(19) United States
(12) Patent Application Publication
(10) Pub. No.: US 2017/0196759 A1
(43) Pub. Date: Jul. 13, 2017

(54) Arrangement in connection with low pressure suction apparatus

(71) Applicant: HLD Healthy Life Devices Oy, Espoo (FI)

(72) Inventors: Kalle Palomäki, Helsinki (FI); Steven Basta, Menlo Park, CA (US)

(73) Assignee: HLD Healthy Life Devices Oy, Espoo (FI)

(21) Appl. No.: 15/401,314

(22) Filed: Jan. 9, 2017

Related U.S. Application Data
(60) Provisional application No. 62/275,814, filed on Jan. 7, 2016.

(51) Int. Cl. A61H 9/00

(52) U.S. Cl. CPC A61H 9/0057; A61H 2205/10; A61H 2205/06; A61H 2205/12; A61H 2205/081; A61H 2201/5023

(57) ABSTRACT

An arrangement in connection with a low pressure suction apparatus for mobilizing skin tissue comprises a low pressure chamber, a suction equipment, comprising for example a pump or a fan, for producing low pressure in the low pressure chamber, and a suction head in connection with the suction apparatus, the suction head comprising a suction cup, one end of which is arranged to be in functional connection with the low pressure chamber and the other is arranged to be pressed against skin tissue, said other end of the suction cup forming a suction opening having a suction opening surface, and the direction parallel to the surface normal of the suction opening surface forming an angle deviating from zero degrees relative to the direction parallel to the surface normal of said one end of the suction cup. An extension handle for a suction apparatus is disclosed.

### PRIORITY

This application claims priority of U.S. provisional application No. 62/275,814 which was filed on Jan. 7, 2016 and the contents of which is incorporated herein by reference.

### TECHNICAL FIELD

The present invention relates generally to low pressure suction, i.e. negative pressure flow, apparatuses for mobilizing skin tissue. Especially, however not exclusively the invention relates to a suction head of the low pressure suction apparatus.

### BACKGROUND

Massage is one way to mobilize skin tissue. It affects skin and muscles in various ways. Massage is a pressing movement applied to soft tissues for treatment purposes, and it is performed in the form of stroking, rubbing, squeezing and different types of tapping. Traditionally, massage aims at improving the metabolism of the musculoskeletal system, relaxing the tension of muscles and maintaining working capacity. Traditionally massage is done by hands, i.e. by handling the skin tissue by manually performed procedures in the above-mentioned manner.

Nowadays massage is performed manually or additionally, more and more often, with different kinds of apparatuses. Certain procedures are carried out practically solely by means of apparatuses.

In addition to traditional relaxing purposes, the abovementioned apparatuses may also be used for plastic and corrective treatment, rheumatic problems, burn injuries, treatment of blood circulation problems, swelling and cellulite, stimulation of the circulation of lymphatic fluids.

Subcutaneous suction massage of fat and connective tissues stimulates metabolism and blood circulation and restores the firmness of tissues, and removes cellulite, swelling and muscle tension, and may alleviate pain related to aforementioned conditions. The treatment is also shown to produce positive results for scar tissue problems, conditions resulting from sports activities, insomnia, and stress.

In the above apparatuses, the massaging method depends on the treatment to be performed. Suction treatment is used especially for treating skin problems, such as cellulite. It is performed using an apparatus consisting of a suction head, which is moved on the skin and connected to the suction apparatus with a flexible cord in order to create a low pressure on the skin as the suction head moves against the patient's body. Low pressure is produced in a low pressure chamber with a suction opening and provided in connection with the suction head. The open part of the low pressure chamber is placed against the skin tissue, whereby the low pressure affects the skin tissue by raising the target area of the skin towards the suction opening.

The prior art teaches apparatuses, in which the low pressure chamber is connected with roller means which are pressed against the skin tissue, as well as apparatuses, in which the low pressure chamber is provided with a surface, which is pressed against the skin tissue and glides on top of the skin tissue as the suction head is moved on the surface of the skin tissue.

A problem with apparatuses known in the field is, for instance, that the sealing of the low pressure chamber has not been optimal in each situation, and this has led to a poorer result. The sealing issue is further magnified when the user uses the apparatus on him/herself. The problem is due to the fact that the elastic properties of the surface of the skin tissue are fairly often variable and the skin tissue also curves strongly in different directions. The radius and direction of curvatures of the skin tissue surface may also vary quite much in different parts of the body, wherefore it has been problematic to achieve a sufficient sealing for the low pressure chamber with prior art apparatuses. Furthermore, it may be difficult for a user in case of self-massage to reach, e.g., skin areas in the back.

### SUMMARY

The objective of the present invention is to provide an arrangement in connection with a low pressure suction apparatus for mobilizing skin tissue that at least alleviates or overcomes one or more problems of the various prior art solutions.

Therefore, according to an embodiment, the present invention is an arrangement in connection with a low pressure suction apparatus for mobilizing skin tissue comprising a low pressure chamber, a suction equipment, comprising for example a pump or a fan, for producing low pressure in the low pressure chamber, and a suction head in connection with the suction apparatus, the suction head comprising a suction cup, one end of which is arranged to be in functional connection with the low pressure chamber and the other is arranged to be pressed towards (and typically against) skin tissue, said other end of the suction cup forming a suction opening having a suction opening surface, and the direction parallel to the surface normal of the suction opening surface forming an angle deviating from zero degrees relative to the direction parallel to the surface normal of said one end of the suction cup. The angle deviation may be 10-80 degrees, advantageously 20-60 degrees, or most advantageously 35-50 degrees.

In various embodiments, the suction cup comprises a first adapter part and a first suction cup part, one end of the first adapter part is arranged to be in functional connection with the low pressure chamber and the other end is arranged to be attached to one end of the first suction cup part, said one end of the first suction cup part being opposite to the other end forming the suction opening having the suction opening surface which is arranged to be pressed towards and typically against the skin tissue, the suction opening surface being substantially parallel relative to said one end of the first suction part, and the surface normal of said other end of the first adapter part forming an angle deviating from zero degrees relative to the direction parallel to the surface normal of said one end of the first adapter part.

In various embodiments, the suction cup comprises a second adapter part and a second suction cup part, one end of the second adapter part is arranged to be in functional connection with the low pressure chamber and the other end is arranged to be attached to one end of the second suction cup part, said one end of the second suction cup part being opposite to the other end forming the suction opening having the suction opening surface which is arranged to be pressed towards and typically against the skin tissue, said one end of the second adapter part being substantially parallel relative to said other end of the second adapter part, and the surface normal of said one end of the suction cup part forming an angle deviating from zero degrees relative to the direction parallel to the surface normal of the suction opening surface.

In various embodiments, the suction cup comprises the second adapter part, the first suction cup part, and a hinge part, said other end of the second adapter part is arranged to be attached to one end of the hinge part, said one end of the first suction cup part is arranged to be attached to the other end of the hinge part, and the surface normal of said other end of the hinge part forming an angle deviating from zero degrees relative to the direction parallel to the surface normal of said one end of the hinge part.

In various embodiments, the suction cup further comprises a sealing part made of a flexible material and arranged to adapt to the shape of the suction opening formed by the suction cup and seal the gap between the end of the suction cup and the skin tissue when the end of the suction cup is pressed against the skin tissue.

In various embodiments, said angle deviating from zero is a fixed angle in the range of about 15-90 degrees, preferably in the range of about 30-60 degrees.

In various embodiments, said angle deviating from zero is a predetermined fixed angle, adjustable in predetermined intervals or a continuously adjustable angle, and substantially retaining the angle when the end of the suction cup is pressed against the skin tissue.

In various embodiments, the angle between the surface normal of the suction opening surface and the surface normal of said one end of the suction cup may be fixed or adjustable. The adjustment may be done continuously or with certain intervals of angles, e.g. about 5, 10 or 20 degrees.

In various embodiments, the angle between the surface normal of the suction opening surface and the surface normal of said one end of the suction cup may be kept at the predetermined position during the use of the apparatus by a locking mechanism of various kinds.

In various embodiments, the longitudinal axis of the suction head is substantially parallel with the surface normal of said one end of the suction cup.

In various embodiments, the surface normal of the suction opening forms an angle deviating from zero and being less or equal to a straight angle.

In various embodiments, the suction cup comprises a sealing part made of a flexible material and arranged at the end of the suction cup that is arranged to be pressed against the skin tissue. The sealing part is arranged to adapt to the shape of the suction opening formed by the suction cup and to seal the gap between the end of the suction cup and the skin tissue when the end of the suction cup is pressed against the skin tissue.

In various embodiments, the suction cup may be made a number of parts. Independent of the number of parts, the suction opening is arranged to one end of the suction cup and the other is in connection with the low pressure chamber.

The present invention is further an arrangement in connection with low pressure suction apparatus for mobilizing skin tissue comprising a low pressure chamber, a suction equipment, comprising for example a pump or a fan, for producing low pressure in the low pressure chamber, a suction head in connection with the suction apparatus, and a preferably releasable extension handle one end of which is arranged to be attached to the suction head.

In various embodiments, the present invention is an arrangement in connection with a low pressure suction apparatus for mobilizing skin tissue comprising a low pressure chamber, a suction equipment for producing low pressure in the low pressure chamber, a suction head in connection with the suction apparatus, and an extension handle, one end of the extension handle being arranged to be attached to the suction head.

In various embodiments, the extension handle comprises a handle part and a body part. The handle part arranged to be attached to one end of the body part, opposite the end which is arranged to be attached to the suction head. The extension handle may be made of any material withstanding the weight of the suction head. The body part of the extension handle may have any suitable shape so as to ease the user of the low pressure suction apparatus to reach the skin tissue in the target area. The shape may be, e.g., semi-circular or having an angle or a plurality of angles.

The various embodiments of the present invention may be utilized to mobilize the skin tissue on various parts of user's body such as, e.g., skin of the head, neck, back, shoulders, armpit, chest, stomach, pelvis, limbs, etc. The target area of the skin may also include scar or fibrotic tissue. By, for example, stretching skin and other tissues and/or stimulating lymphatic flow certain medical conditions, such as pain, may be ameliorated by the use of arrangement according to the present invention and, thus, even facilitate reduction in usage of pain medication. It may be done by a therapist or any other operator of the apparatus or by the user as self-treatment.

Relying on an apparatus according to an embodiment of the present invention may in many cases turn out advantageous also to the user or operator in contrast to e.g. manual therapy. The elbows, wrists, and hands of the operator may be spared from fatigue and pain, which are commonly induced by lengthy days of manual therapy.

Various other advantages will become clear to a skilled person based on the following detailed description.

The expression “a number of” refers herein to any positive integer starting from one (1), e.g. to one, two, or three.

The expression “a plurality of” refers herein to any positive integer starting from two (2), e.g. to two, three, or four.

The terms “first” and “second” do not denote any order, quantity, or importance, but rather are used to distinguish one element from another.

The exemplary embodiments of the invention presented in this patent application are not to be interpreted to pose limitations to the applicability of the appended claims. The verb “to comprise” is used in this patent application as an open limitation that does not exclude the existence of also un-recited features. The features recited in depending claims are mutually freely combinable unless otherwise explicitly stated.

The novel features which are considered as characteristic of the invention are set forth in particular in the appended claims. The invention itself, however, both as to its construction and its method of operation, together with additional objectives and advantages thereof, will be best understood from the following description of specific embodiments when read in connection with the accompanying drawings.

### BRIEF DESCRIPTION OF FIGURES

FIG. 1 illustrates schematically an embodiment of a low pressure suction apparatus in accordance with the present invention.

FIG. 2 illustrates schematically an embodiment of a low pressure suction apparatus in accordance with the present invention.

FIGS. 3A-3B illustrate embodiments of a suction cup of the suction head in connection with the low pressure suction apparatus in accordance with the present invention.

FIGS. 4A-4B illustrate embodiments of a sealing part of the suction head in accordance with the present invention.

FIGS. 5A-5D illustrate schematically various embodiments of a suction cup in accordance with the present invention.

FIG. 6 illustrates schematically an embodiment of an extension handle in connection with the suction head of the low pressure suction apparatus in accordance with the present invention.

FIG. 7 illustrates schematically various embodiments of the extension handle in connection with the suction head of the low pressure suction apparatus in accordance with the present invention.

### DETAILED DESCRIPTION

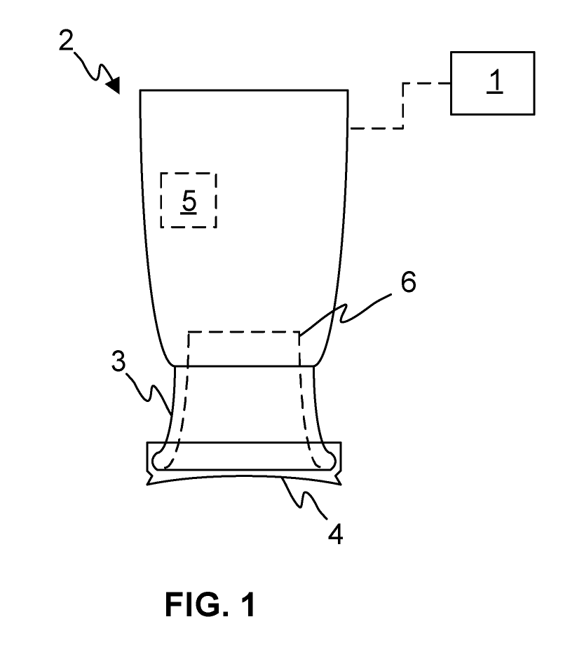

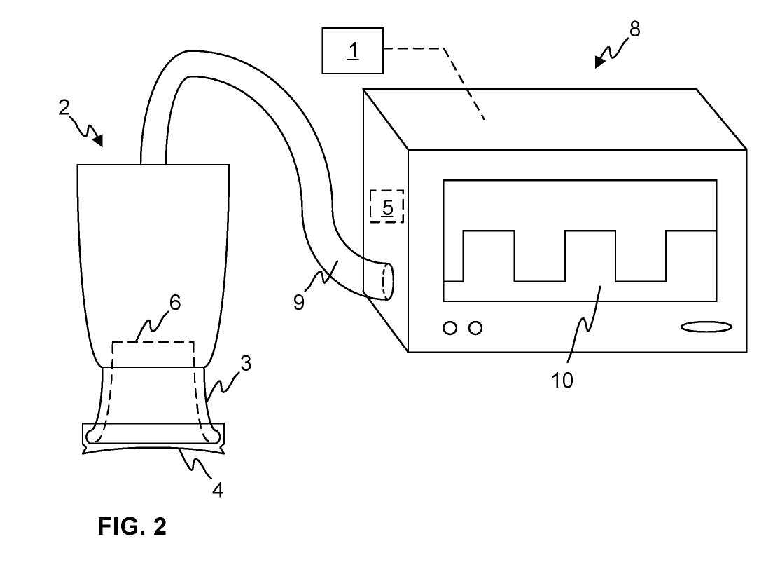

With reference to FIGS. 1 and 2, embodiments of the low pressure suction apparatus, or ‘device’, comprise a suction head 2, a central processing unit 1, a suction cup 3, a sealing part 4, a low pressure chamber 6 and a suction equipment for producing the low pressure in the low pressure chamber 5. The suction equipment comprises one or several of various means for producing the low pressure by e.g. a pump or a fan. The central processing unit 1 may be arranged in connection with the suction head 2 or in connection with a central unit 8 as shown in FIG. 2. The low pressure chamber 6 and the suction equipment/means for producing low pressure in the low pressure chamber 5 are shown schematically by dashed lines in FIGS. 1 and 2. The means for producing the low pressure 5 (negative pressure flow/suction effect), e.g. with a vacuum pump or a fan, may be in the suction head 2 or in the central unit 8 in which case the means for producing the low pressure 5 is arranged in connection with the suction head 2, e.g., by a hose 9. There may be a display in the suction head 2 and/or 10 in the central unit 8. The central unit 8 may further incorporate an interface for an external display. In some embodiments, the features of a central unit 8 could even be combined with the suction head 2 into an integral apparatus. In some embodiments, the pump or fan 5 could be included in the suction head 2 while there is still provided a central unit 8 or similar element connected to the head 2 by a flexible element such as a cable or wiring for electricity and/or data transfer, for example. These types of embodiments would not obviously necessitate the use of a hose 9 for the suction flow between the elements 2, 8. When the pump or fan 5 is located within a common housing with the chamber 6, these two may still be connected via internal piping, hose(s) and/or duct(s), for example, for conveying the low pressure flow.

In addition, in case of an embodiment of the suction apparatus with a central unit 8 is utilized, the hose 9 may have a valve which is advantageously positioned near the low pressure chamber 6. The speed of the system may further be improved by using the hose 9 as a low pressure reservoir. Thus, higher or lower pressure may be achieved in the hose 9 compared to the pressure desired in the low pressure chamber 6, especially in case a central unit 8 is utilized. If, for example, change of pressure from 150 to 200 mmHg is desired, the pressure of the low pressure chamber 6 is 150 mmHg and if in the subsequent phase a pressure of 200 mmHg is desired, the pressure of the hose 9 may already be set for example to 500 mmHg, so that upon opening of the valve a pressure of 200 mmHg is achieved quickly in the low pressure chamber 6 and the valve may be closed. The valve may be arranged to be controlled by pulse width modulation for adjusting the low pressure in the low pressure chamber 6. In some embodiments the valve may control (mechanical) higher frequency oscillation produced in addition to lower frequency suction pulses. Alternatively, higher frequency oscillation could be produced by other element(s), such as electric motor or ‘vibrator’. In some embodiments, the oscillation could be at least temporarily solely produced (i.e. no simultaneous lower frequency pulsation).

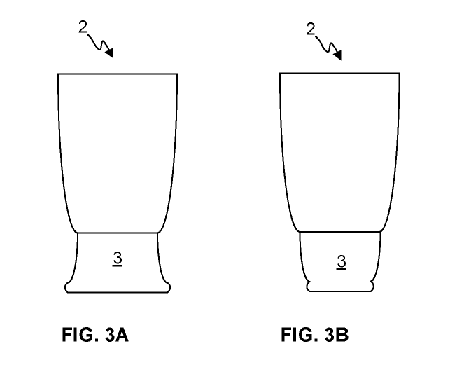

FIGS. 3A and 3B illustrate two embodiments of the suction cup 3, one end of which is arranged to be in connection with the low pressure chamber 6 and the other end of which is arranged to be pressed towards (meaning in this application a degree of contact or a magnitude of force from a gentle touch/contact to more intense pressing) the skin tissue to direct low pressure suction to the target area, typically skin tissue, thus producing a bulge in the skin tissue. The skin preferably refers herein to all skin layers i.e. epidermis, dermis, hypodermis or subcutis. The target area of the skin may also have scar(s) or fibrotic tissue.

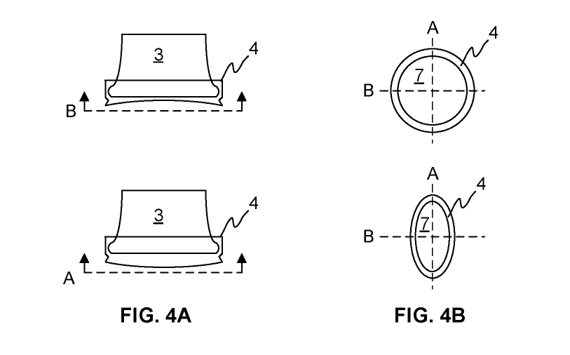

In FIGS. 3A and 3B, the end of the suction cup 3 that is arranged to be pressed towards (typically against) the skin tissue is the lower end of the suction cup 3. The suction cup 3 is arranged to form a suction opening 7 (shown in FIG. 4B). FIGS. 3A and 3B illustrates two different shapes of the suction cup. There may also be other shapes and, thus, the examples in FIGS. 3A and 3B are not shown to pose limitations to the suction apparatus according to the present invention. The suction cup 3 with an appropriate size, shape and/or material may be chosen based on the nature or size of the target area of the skin to be treated, for instance.

The suction cup 3 may further comprise a sealing part 4 advantageously made of a flexible material and arranged at the end of the suction cup 3 that is arranged to be pressed against the skin tissue and to adapt to the shape of the suction opening 7 formed by the suction cup 3 and to seal the gap between the end of the suction cup 3 and the skin tissue when the end of the suction cup 3 is pressed against the skin tissue.

The sealing part 4 may be made of any suitable flexible material, such as polyurethane or elastomeric material. The use of other plastic materials and silicon material is also possible. At the sealing part 4, it is naturally also possible to use a suitable material that reduces or increases the friction between the sealing part 4 and the skin tissue, and/or a material that improves the sealing, depending on whether the objective is to achieve a good mobility for the suction head or as high a friction force as possible. Mobility may also be increased by using a number rotating elements, such as rollers, which are in connection with the suction cup 3. The rotating elements, in addition to the sealing part 4, may also provide sealing function between the skin and the suction cup 3.

As the suction head 2 of the suction apparatus is moved against the patient's skin, most comfortably using a handle, the effect of the low pressure causes a fold of skin to be pulled up into the low pressure chamber 6.

FIGS. 4A and 4B illustrate the shape of the sealing part 4 by side views from two substantially perpendicular directions. The sealing part 4, which is to be pressed against the skin tissue, is arranged to be concave in the direction of at least one of the main axes A or B of the suction opening 7 formed by the suction cup 3.

In an embodiment of the suction cup 4 of the suction apparatus shown in FIG. 4A, the surface of the sealing part 4 to be pressed against the skin tissue is concave in the direction of the main axis B of the suction opening 7 formed by the suction cup 3. The shape of the suction opening 7 may be elliptical or oval or round (some examples are shown in FIG. 4B). However, these are not the only feasible embodiments but other shapes may be used as well.

In the above examples, the sealing part 4 is shown as a separate part fastened to the end of the suction cup 3. The sealing part 4 may be a disposable part, which is detached after use and replaced by a new one in the beginning of the treatment of a new patient. Alternatively, the sealing part 4 may be reusable after washing or disinfecting. The fastening to the end of the suction cup 3 may be achieved by means of various connections. At the end of the suction cup 3, which is to be pressed against the patient's skin, there may be a flange in the radial direction, which is used for fastening the sealing part 4 made of a flexible material to its place. Thus, the schematically shown connection of the sealing part 4 in figures is not to be understood as a factor limiting the embodiments of the suction apparatus used in connection with the method according to the present invention. It is also to be noted in this context that the sealing part or portion 4 may be formed as an integral part of the suction cup 3, for instance.

In various embodiments, an opening for subjecting the target tissue such as skin to the suction may be defined by a suction cup 3 (part or portion) of the suction head 2. The suction cup may be adaptable in size to best fit the shape of the treated body part. The adaptability may be implemented by a plurality of interchangeable cups of different size and/or by an adjustable cup. For example, the applicable size may range from about 10 or 20 mm to 80 or 90 mm in diameter depending on the dimensions and shape of the target area. As a general rule, a largest cup considered suitable for the area may be selected. For instance, 60-80 mm size may be more suitable for the neck than for facial areas that benefit from using a smaller diameter cup and related opening.

The diameter of an optimum cup generally varies between user and from an applied technique to another, but in standard case it may range from about 60 mm to about 80 mm, for example. As an applicable basic rule, one could consider to select the largest suitable treating cup for each target area. Fastening of the treatment cup having regard to the rest of the treatment head may incorporate grooves (in the cup or head) and matching lips (in the head or cup, respectively), snap fastener(s), threads, magnets, frictional and/or pressure contact (e.g. based on the elasticity (enabling stretching) and/or roughness of the contacting surface(s) yielding tight, secure fit), or any combination of the above or other feasible attachment technologies providing e.g. sufficiently secure and airtight fit between the connected elements.

The suction apparatus is thus not restricted to the examples of the figures in any way, but the apparatuses may be varied entirely freely within the scope of the claims. Thus, it is clear that the invention is by no means restricted to any specific shape or dimension of the suction cup 3 or other components, for instance, but the shape and/or dimensions of the different elements and parts of the invention may differ from one another freely between embodiments, if desired. The idea of the present invention may even be applied in connection with such suction heads at which rotating elements such as rollers are employed, as mentioned hereinbefore.

The low pressure in the low pressure chamber 6 is advantageously produced by using the aforementioned vacuum pump. Necessary adjusting valves are also advantageously mounted in connection with the vacuum pump.

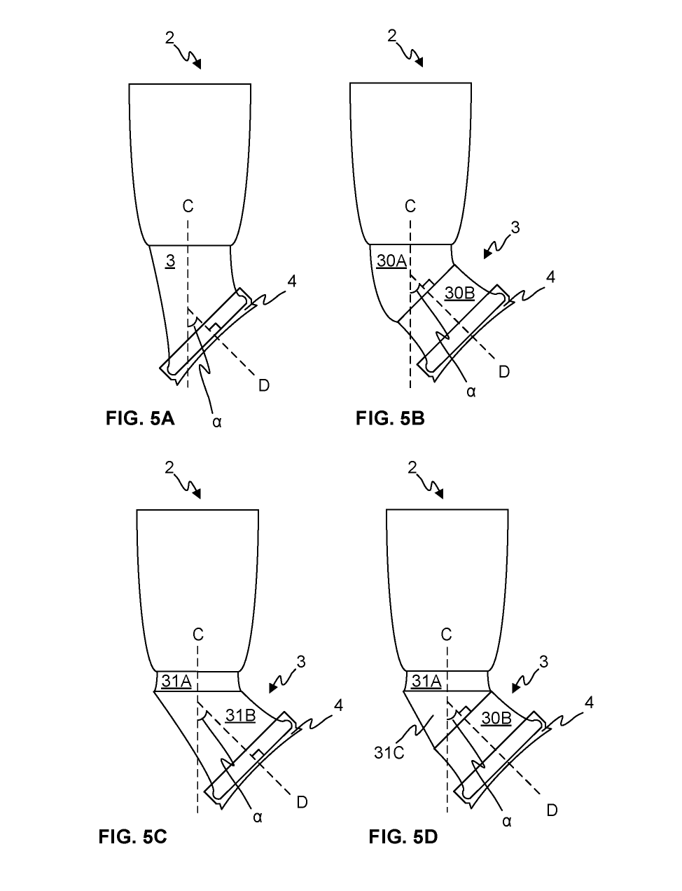

FIGS. 5A-5D illustrate various embodiments of a suction cup 3 according to the present invention. Variable angle of the suction cup 3 may be achieved by using a plurality of interchangeable suction cups of different size, shape and with an angle a between the axis D, which is substantially normal to the suction opening surface, and the axis C which is parallel to the surface normal of the end of the suction cup in connection with the low pressure chamber 6 and which is arranged to be attached to the suction head 2, and/or by a suction cup having a continuously adjustable angle a or is adjustable in predetermined intervals of the angle a described hereinafter.

In FIG. 5A, the angle of the suction cup 3 is achieved by forming the suction cup such that the axis D of the suction opening surface which has an angle a relative to the axis C which is parallel to the surface normal of the end of the suction cup in connection with the low pressure chamber. The angle a may be any angle deviating from zero degrees, preferably up to 90 degrees. In the embodiment shown in FIG. 5A, the suction cup 3 is made of one piece and can thus be easily installed and can be designed to be essentially airtight in order to minimize the low pressure produced in the low pressure chamber 6 from leaking out. There may be, in addition to different angles a, a plurality of different sizes and shapes of the suction cups 3 so as to produce suitable suction heads 2 for different target areas of the skin tissue.

In FIG. 5A, the suction cup 3 may also be such it can be configured to have any angle a deviating from 0 degrees, preferably up to 90 degrees. The configuring of the angle of the suction cup 3 can be done, e.g., continuously to achieve any angle deviating from 0 degrees or it may be done so that there are some predetermined angles, e.g., from 10 to 90 degrees in the intervals of 5, 10 or 20 degrees. Preferably, once the angle has been chosen, the angle of the suction cup 3 remains constant during the use of the suction apparatus. This can be achieved, e.g., by using a locking mechanism arranged in connection with the suction cup 3. The locking mechanism may, e.g., be based on utilizing a spring, a hook, a pin, a rotatable locking mechanism, etc.

FIG. 5B illustrates another embodiment of the suction cup 3 according to the present invention comprising two parts: a first adapter part 30A and a first suction cup part 30B. One end of the first adapter part 30A can be attached to the suction head 2 and the other end to the end of the first suction cup part 30B which is opposite to the end of the first suction cup part 30B to be pressed against the skin tissue. The axis D of the other end of the first adapter part 30A, which to be attached to the first suction cup part 30B, may have any angle a deviating from zero degrees, preferably up to 90 degrees, relative to the axis C which is parallel to the surface normal of the end of the suction cup 2 in connection with the low pressure chamber 6. Both ends of the first suction cup part 30B are substantially parallel relative to each other. The first suction cup part 30B may thus be attached to a plurality of first adapter parts 30A having different angles α.

According to the embodiment of the present invention shown in FIG. 5B, the other end of the first adapter part 30A, which is to be attached to the first suction cup part 30B, may have a particular size and shape, whereas the suction opening 7 of the first suction cup part 30B may have a plurality of different sizes and shapes as well. Thus, the angle of the suction cup 3 is determined by choosing the suitable first adapter part 30A and the shape and size of the suction opening 7 is based on choosing the suitable first suction cup part 30B.

In FIG. 5B, the first adapter part 30A may also be such it can be configured to have any angle a deviating from zero degrees, preferably up to 90 degrees. The configuring of the angle of the first adapter part 30A can be done, e.g., continuously to achieve any angle deviating from zero degrees, preferably up to 90 degrees or it may be done so that there are some predetermined angles, e.g., from 10 to 90 degrees in the intervals of 5, 10 or 20 degrees. Preferably, once the angle has been chosen, the angle determined by the first adapter part 30A remains constant during the use of the suction apparatus. This can be achieved, e.g., by using a locking mechanism arranged in connection with the suction cup 3 mentioned herein earlier, in this case particularly in connection with the first adapter part 30A and/or the first suction cup part 30B.

FIG. 5C illustrates another embodiment of the suction cup 3 according to the present invention. The suction cup 3 comprises two parts: a second adapter part 31A and a second suction cup part 31B. One end of the second adapter part 31A is to be attached to the suction head 2 and the other end to the end of the second suction cup part 31B which surface normal is parallel to the axis C which is parallel to the surface normal of the end of the suction cup in connection with the low pressure chamber and which is opposite to the end of the second suction cup part 30B to be pressed against the skin tissue. The axis D of the one end of the second suction cup part 31B, which to be attached to the second adapter part 31A, may have any angle a deviating from zero degrees, preferably up to 90 degrees, relative to axis D, parallel to the surface normal of the other end of the second suction cup part 30.

As shown in FIG. 5C, the second suction cup part 31B can be attached to the second adapter part 31A. The attachment of the second adapter part 31A to the second suction cup part 31B may be such that the second suction cup part 31B remains stationary in use with a fixed angle α. The attachment may also be such that the second suction cup part 31B can be rotated. Preferably, the rotatable attachment is such that the second suction cup part 31B may be rotated to the desired position after which it remains substantially in the desired position when applying the suction to the target area of the skin tissue. This can be achieved by a locking mechanism mentioned herein earlier arranged in connection with the suction cup 3, in this case particularly in connection with the second adapter part 31A and/or the second suction cup part 31B.

FIG. 5D illustrates another embodiment of the suction cup 3 according to the present invention. The suction cup 3 comprises three parts: the second adapter part 31A, a hinge part 31C and the first suction cup part 30B. Both ends of the second adapter part 31A are substantially parallel relative to each other. Furthermore, both ends of the first suction part 30B are also substantially parallel relative to each other. The variable angle of the suction cup is achieved with the hinge part 31C, one end of which is to be attached to the other end of the second adapter part 31A and the other end to the end of the first suction cup part 30B opposite to the end to be pressed against the skin tissue. The axis of the end of the hinge part 31C to be attached to the second adapter part 31A is substantially parallel to the axis C which is parallel to the surface normal of the end of the suction cup in connection with the low pressure chamber. The axis D normal to the surface of the other end of the hinge part 31C may have any angle a deviating from zero degrees, preferably up to about 90 degrees, relative to the axis C which is parallel to the surface normal of the end of the suction cup 3 in connection with the low pressure chamber 6.

The hinge part 31C may be such that the variable angle achieved is constant and thus, if desired, different angles may be achieved by using hinge parts 31C with corresponding angles. The hinge part 31C may also be such it can be configured to have any angle a from more than about 0 to 90 degrees. The configuring of the angle of the hinge part 31C can be done, e.g., continuously to achieve any angle from more than about 0 to 90 degrees or it may be done so that there are some predetermined angles, e.g., from about 10 to 90 degrees in the intervals of about 5, 10 or 20 degrees. Preferably, once the angle has been chosen, the angle of the hinge part 31C remains constant during the use of the suction apparatus. This can be achieved by a locking mechanism mentioned herein earlier arranged in connection with the suction cup 3, in this case particularly in connection with the hinge part 31C.

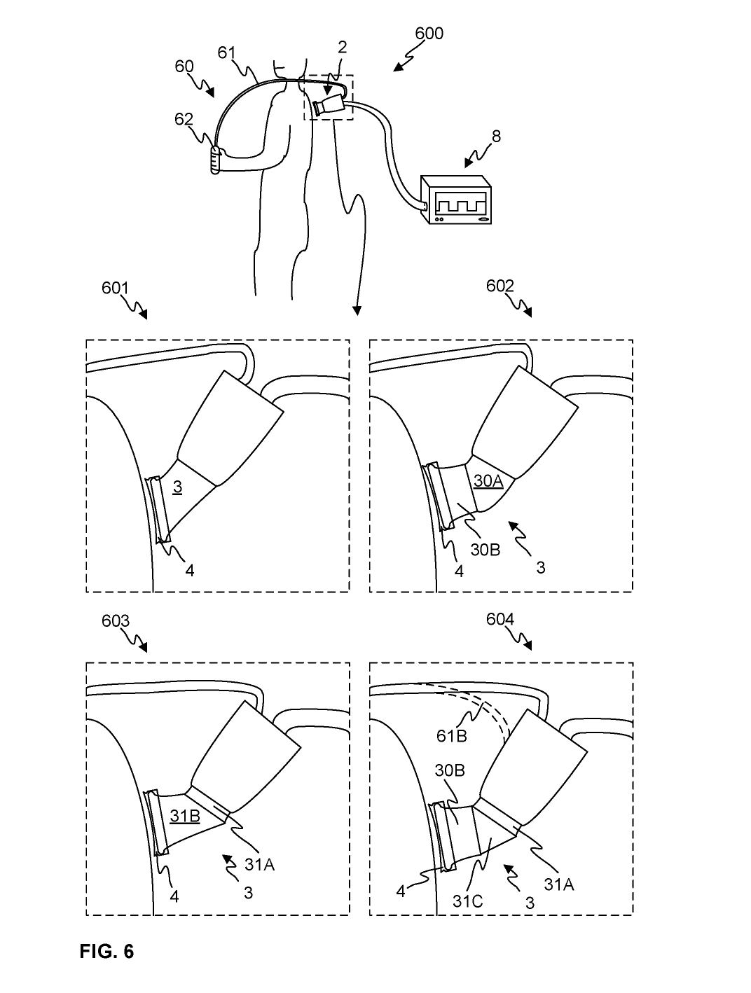

FIG. 6 illustrates an extension handle 60 for the low pressure suction apparatus according to the present invention. The extension handle 60 has a body part 61 and a handle part 62. One end of the body 61 is arranged to be attached to one end of the handle part 62, which may comprise a grip portion, and the other end to the suction head 2. Preferably, the extension handle 60 is arranged to be attached to the end of the suction head 2 opposite to the end to which the suction cup 3 is attached but may also be arranged to be attached to other locations of the suction head 3.

The suction cup 3 of the suction head 2 may be such as in the embodiment in FIGS. 3A and 3B in which the suction opening 7 formed by the suction cup 3 is substantially perpendicular to the longitudinal axis C of the suction head 2. In FIG. 6, corresponding embodiments of the suction cups shown in FIG. 5A-5D are shown at 601-604 inside the rectangular boxes marked with dashed lines. Embodiment of the suction cup 3 shown in FIGS. 1 and 2 is shown at 600. By using an appropriate suction cup 3 with, e.g. 45 degree angle, it is easier to the user to use to low pressure suction apparatus to the target area of the skin. The extension handle 60 may also have different shape than in the one shown in FIG. 5. The figure is not shown to pose limitation to the scope of the present invention. It may be, e.g. so that the extension handle 60 has a semi-circular shape or has a straight angle or various different angles. It is obvious that suitable extension handles can be designed specifically for different areas of user's body.

The extension handle 60 may be made of any suitable substantially solid material that can withstand the weight of the suction head 2 of the low pressure suction apparatus such as e.g. plastic or metal or wood.

In one embodiment, the extension handle 60 is attached to a suction head 2 such as the one shown in FIG. 1 in which the angle α of the suction cup is zero, or about zero, as shown in FIG. 6 at 600. The angle between the direction parallel to the surface normal of the suction opening surface and the longitudinal axis of the handle part 62 of the extension handle 60 is determined by the shape of the body part 61 of the extension handle 60 or by the corners/angles/curves in the body part 61. In this case the angle deviating from zero degrees is formed between the two abovementioned directions (normal of the suction opening surface and the direction parallel to the longitudinal axis of the handle part 62). The angle may be, e.g., anything deviating from zero degrees such as 45, 90, 135, 180, 225, or 270, but less than 360 degrees (which in this application is equal to zero degrees).

In various embodiments, one end of the extension handle 60 is, preferably, arranged to be attached to the end of the suction head opposite to the end at which the suction cup 3 is attachable such as shown in FIG. 6. In some embodiments, the one end of the extension handle 60 may be attachable to the side of the suction head 3 (such as shown at 604 at 61B with dashed lines as an alternative spot to attach the one end of the extension handle 60) which (the side) is approximately parallel to the longitudinal axis of the suction head 3.

The body part 61 of the extension handle 60 may also be made of bendable/moldable (by hand) material capable of withstanding the weight of the suction head 2, such as e.g. made of aluminum. The body part 61 may also comprise consecutive pivotal elements due to which the body part 61 may be bent/shaped into various shapes such as, e.g., S-, U- or hook-shape.

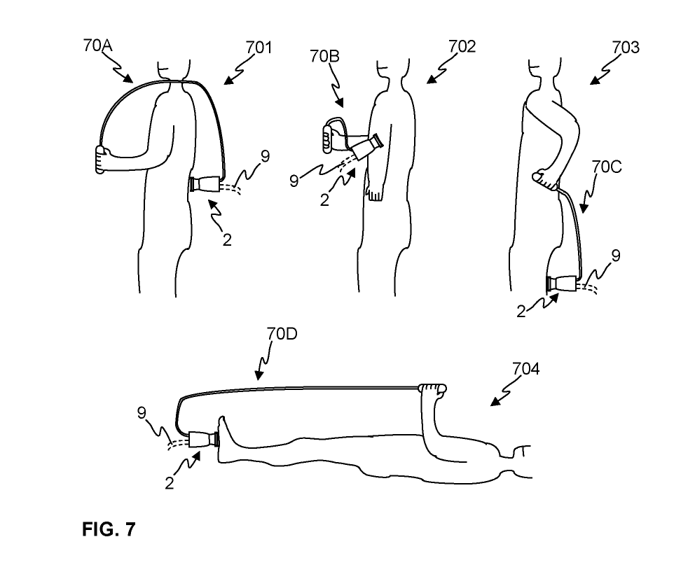

FIG. 7 illustrates various embodiments and use scenarios of the extension handle 70A-70D, at 701-704, in addition to one shown in FIG. 6 at 600. At 701, the extension handle, particularly its body part, has a shape, resembling U- or C-shape, that enables user to apply low pressure suction to the area of lower back. Some users may have limited range of motion, e.g. in one arm, and may thus benefit from an extension handle 70B such as shown at 702 which resembles the shape of S. Extension handles 70C, 70D shown at 703 and 704 may be used when applying the low pressure suction to areas of limbs or extremities of a body, such as to the sole of a foot. These are especially useful for users with limited range of motion performing self-treatment. The extension handle 70D at 704 has an elongated body part capable of reaching the sole of a foot. The angles or corners of the body part are located close to the suction head 2. There may, however, be a number of angles or corners in different locations of the body part 61 of the extension handle 60, 70A-70D.

In some embodiments, the handle 60 may incorporate one or more UI (user interface) elements such as at least one switch, button, touchpad, touchscreen, keypad, indicator light, display, etc. for controlling or verifying the state of the apparatus. The handle 60 may incorporate e.g. an electrical connection means, such as electrical wiring and necessary connector(s), for transferring related signals between the UI element and the apparatus, e.g. the central unit or central processing unit thereof. Alternatively or additionally, the connection means may be mechanical (comprise e.g. rods, lines, gears, shafts, levers).

Further, the handle 60 may comprise articulated part(s), such as hinges or joints, which enable changing their mutual position or alignment, for example.

Features described in the preceding description may be used in combinations other than the combinations explicitly described. Although functions have been described with reference to certain features, those functions may be performable by other features whether described or not. Although features have been described with reference to certain embodiments, those features may also be present in other embodiments whether described or not.

1. An arrangement for use in connection with a low pressure suction apparatus for mobilizing skin tissue, said apparatus comprising a low pressure chamber, a suction equipment for producing low pressure in the low pressure chamber and a suction head, the arrangement comprising a suction cup for the suction head, one end of which is arranged to be in functional connection with the low pressure chamber and the other end of the suction cup arranged to be pressed towards skin tissue, said other end of the suction cup forming a suction opening having a suction opening surface, and the direction parallel to the surface normal of the suction opening surface forming an angle substantially deviating from zero degrees relative to the direction parallel to the surface normal of said one end of the suction cup.

2. The arrangement of claim 1, wherein the suction cup comprises a first adapter part and a first suction cup part, one end of the first adapter part is arranged to be in functional connection with the low pressure chamber and the other end is arranged to be attached to one end of the first suction cup part, said one end of the first suction cup part being opposite to the other end forming the suction opening having the suction opening surface which is arranged to be pressed against the skin tissue, the suction opening surface being substantially parallel relative to said one end of the first suction part, and the surface normal of said other end of the first adapter part forming an angle deviating from zero degrees relative to the direction parallel to the surface normal of said one end of the first adapter part.

3. The arrangement of claim 1, wherein the suction cup comprises a second adapter part and a second suction cup part, one end of the second adapter part is arranged to be in functional connection with the low pressure chamber and the other end is arranged to be attached to one end of the second suction cup part, said one end of the second suction cup part being opposite to the other end forming the suction opening having the suction opening surface which is arranged to be pressed against the skin tissue, said one end of the second adapter part being substantially parallel relative to said other end of the second adapter part, and the surface normal of said one end of the suction cup part forming an angle deviating from zero degrees relative to the direction parallel to the surface normal of the suction opening surface.

4. The arrangement of claim 1, wherein the suction cup comprises the second adapter part, the first suction cup part, and a hinge part, said other end of the second adapter part is arranged to be attached to one end of the hinge part, said one end of the first suction cup part is arranged to be attached to the other end of the hinge part, and the surface normal of said other end of the hinge part forming an angle deviating from zero degrees relative to the direction parallel to the surface normal of said one end of the hinge part.

5. The arrangement of claim 1, wherein the suction cup further comprises a sealing part made of a flexible material and arranged to adapt to the shape of the suction opening formed by the suction cup and seal the gap between the end of the suction cup and the skin tissue when the end of the suction cup is pressed against the skin tissue.

6. The arrangement of claim 1, wherein said angle deviating from zero is a predetermined fixed angle, adjustable in predetermined intervals or a continuously adjustable angle, and substantially retaining the angle when the end of the suction cup is pressed against the skin tissue.

7. The arrangement of claim 1, wherein said angle deviating from zero falls within a range of 10-80 degrees.

8. The arrangement of claim 1, wherein said angel deviating from zero falls within a range of 20-60 degrees.

9. The arrangement of claim 1, wherein said angel deviating from zero falls within a range of 35-50 degrees.

10. An arrangement comprising a low pressure suction apparatus for mobilizing skin tissue comprising a low pressure chamber, a suction equipment for producing low pressure in the low pressure chamber, and a suction head in connection with the suction apparatus, and a preferably releasably connectable extension handle, one end of the extension handle being arranged to be attached to the suction head and the other end being configured for being held by an operator of the apparatus.

11. The arrangement of claim 10, wherein the extension handle comprises a handle part at the other end of the extension handle configured for being held by an operator of the apparatus, and the longitudinal axis of the handle part forms an angle deviating from zero degrees relative to the direction parallel to the surface normal of the suction opening surface.

12. The arrangement of claim 10, wherein the extension handle is configured so as to enable a patient with limited flexibility to be able to treat their lower limbs if they are otherwise unable to reach or treat certain areas of their lower limbs without the aid of the extension or flexible treatment head.

13. The arrangement of claim 10, wherein the extension handle, or flexible angle in the handle or at the treatment head is configured so as to enable the patient to treat themselves including areas of the back which could otherwise not be adequately reached by a patient without the aid of the extension or bent or angled handle or treatment head.
